(19) United States
(12) Patent Application Publication
(10) Pub. No.: US 2026/0190137 A1
(43) Pub. Date: Jul. 2, 2026

(54) METHODS, SYSTEMS, AND APPARATUSES FOR ENHANCING PRIORITIZED TRAFFIC EXCHANGE USING ENHANCED DISTRIBUTED CHANNEL ACCESS

(71) Applicant: Nokia Technologies Oy, Espoo (FI)

(72) Inventors: Salvatore TALARICO, Sunnyvale, CA (US); Behnam DEZFOULI, San Jose, CA (US); Klaus Franz DOPPLER, Albany, CA (US); Orhan Okan MUTGAN, Munich (DE); Mika KASSLIN, Espoo (FI)

(21) Appl. No.: 19/003,954

(22) Filed: Dec. 27, 2024

(51) Int. Cl. H04L 47/24; H04L 47/27

(52) U.S. Cl. CPC H04W 72/56; H04L 47/24; H04W 74/0841

(57) ABSTRACT

Methods, systems, apparatuses, and computer program products for enhancing prioritized traffic exchange using enhanced distributed channel access are disclosed herein. In an implementation, one or more prioritized access parameters to be utilized for data traffic that satisfies at least one priority criterion for accessing a data channel are received, a transmission opportunity for one or more data frames via the data channel is obtained based on the one or more prioritized access parameters, and the one or more data frames are transmitted via the data channel.

### TECHNICAL FIELD

Various example embodiments relate generally to communication systems and, more particularly, to wireless network functionality related to prioritizing data traffic for a communication network.

### BACKGROUND

Wireless communication networks, such as wireless fidelity (Wi-Fi) networks, may support latency-sensitive applications at Wi-Fi stations (STAs). Such latency-sensitive applications may include virtual reality (VR) applications, mixed reality (MR) applications, augmented reality (AR) applications, extended reality (XR) applications, or applications that utilize sensors which detect events to be reported with low latency. However, in some cases, the default procedures for channel access of a wireless communication network may constrain the performance of the latency-sensitive applications and/or the wireless communication network.

### BRIEF DESCRIPTION

According to some aspects, there is provided the subject matter of the independent claims. Some further aspects are defined in the dependent claims. The embodiments that do not fall under the scope of the claims are to be interpreted as examples useful for understanding the disclosure.

In an example embodiment, an apparatus is provided. In one or more embodiments, the apparatus comprises at least one processor and at least one memory storing instructions. In one or more embodiments, the instructions, when executed by the at least one processor, cause the apparatus to receive one or more prioritized access parameters to be utilized for data traffic that satisfies at least one priority criterion for accessing a data channel. In one or more embodiments, the instructions, when executed by the at least one processor, additionally or alternatively cause the apparatus to obtain a transmission opportunity for one or more data frames via the data channel based on the one or more prioritized access parameters. In one or more embodiments, the instructions, when executed by the at least one processor, additionally or alternatively cause the apparatus to transmit the one or more data frames via the data channel.

In one or more embodiments, the apparatus is additionally or alternatively configured to receive the one or more prioritized access parameters via a management frame associated with the data channel.

In one or more embodiments, the apparatus is additionally or alternatively configured to receive information associated with a window for utilization of the one or more prioritized access parameters via the data channel. In one or more embodiments, the apparatus is additionally or alternatively configured to transmit the one or more data frames based on the window.

In one or more embodiments, the one or more prioritized access parameters comprise a prioritized access parameter associated with arbitration inter-frame spacing (AIFS) information for the data channel.

In one or more embodiments, the one or more prioritized access parameters additionally or alternatively comprise a prioritized access parameter associated with a contention window size for the data channel.

In one or more embodiments, the one or more prioritized access parameters additionally or alternatively comprise a prioritized access parameter associated with a transmission opportunity limit for the data channel.

In one or more embodiments, the one or more prioritized access parameters are included in an augmented set of enhanced distributed channel access (EDCA) parameters for the data channel.

In an example embodiment, a method is provided. In one or more embodiments, the method comprises receiving one or more prioritized access parameters to be utilized for data traffic that satisfies at least one priority criterion for accessing a data channel. In one or more embodiments, the method additionally or alternatively comprises obtaining a transmission opportunity for one or more data frames via the data channel based on the one or more prioritized access parameters. In one or more embodiments, the method additionally or alternatively comprises transmitting the one or more data frames via the data channel.

In one or more embodiments, the method additionally or alternatively comprises receiving the one or more prioritized access parameters via a management frame associated with the data channel.

In one or more embodiments, the method additionally or alternatively comprises receiving information associated with a window for utilization of the one or more prioritized access parameters via the data channel. In one or more embodiments, the method additionally or alternatively comprises transmitting the one or more data frames based on the window.

In one or more embodiments, the one or more prioritized access parameters comprise a prioritized access parameter associated with AIFS information for the data channel.

In one or more embodiments, the one or more prioritized access parameters additionally or alternatively comprise a prioritized access parameter associated with a contention window size for the data channel.

In one or more embodiments, the one or more prioritized access parameters additionally or alternatively comprise a prioritized access parameter associated with a transmission opportunity limit for the data channel.

In one or more embodiments, the one or more prioritized access parameters are included in an augmented set of EDCA parameters for the data channel.

In another example embodiment, a non-transitory computer-readable storage medium is provided. In one or more embodiments, the non-transitory computer-readable storage medium includes program instructions stored thereon that are configured to receive one or more prioritized access parameters to be utilized for data traffic that satisfies at least one priority criterion for accessing a data channel. In one or more embodiments, the non-transitory computer-readable storage medium additionally or alternatively includes program instructions stored thereon that are configured to obtain a transmission opportunity for one or more data frames via the data channel based on the one or more prioritized access parameters. In one or more embodiments, the non-transitory computer-readable storage medium additionally or alternatively includes program instructions stored thereon that are configured to transmit the one or more data frames via the data channel.

In one or more embodiments, the non-transitory computer-readable storage medium additionally or alternatively includes program instructions stored thereon that are configured to receive the one or more prioritized access parameters via a management frame associated with the data channel.

In one or more embodiments, the non-transitory computer-readable storage medium additionally or alternatively includes program instructions stored thereon that are configured to receive information associated with a window for utilization of the one or more prioritized access parameters via the data channel. In one or more embodiments, the non-transitory computer-readable storage medium additionally or alternatively includes program instructions stored thereon that are configured to transmit the one or more data frames based on the window.

In one or more embodiments, the one or more prioritized access parameters comprise a prioritized access parameter associated with AIFS information for the data channel.

In one or more embodiments, the one or more prioritized access parameters additionally or alternatively comprise a prioritized access parameter associated with a contention window size for the data channel.

In one or more embodiments, the one or more prioritized access parameters additionally or alternatively comprise a prioritized access parameter associated with a transmission opportunity limit for the data channel.

In one or more embodiments, the one or more prioritized access parameters are included in an augmented set of EDCA parameters for the data channel.

In yet another example embodiment, an apparatus is provided. In one or more embodiments, the apparatus provides means for receiving one or more prioritized access parameters to be utilized for data traffic that satisfies at least one priority criterion for accessing a data channel. In one or more embodiments, the apparatus additionally or alternatively provides means for obtaining a transmission opportunity for one or more data frames via the data channel based on the one or more prioritized access parameters. In one or more embodiments, the apparatus additionally or alternatively provides means for transmitting the one or more data frames via the data channel.

In one or more embodiments, the apparatus additionally or alternatively provides means for receiving the one or more prioritized access parameters via a management frame associated with the data channel.

In one or more embodiments, the apparatus additionally or alternatively provides means for receiving information associated with a window for utilization of the one or more prioritized access parameters via the data channel. In one or more embodiments, the apparatus additionally or alternatively provides means for transmitting the one or more data frames based on the window.

In one or more embodiments, the one or more prioritized access parameters comprise a prioritized access parameter associated with AIFS information for the data channel.

In one or more embodiments, the one or more prioritized access parameters additionally or alternatively comprise a prioritized access parameter associated with a contention window size for the data channel.

In one or more embodiments, the one or more prioritized access parameters additionally or alternatively comprise a prioritized access parameter associated with a transmission opportunity limit for the data channel.

In one or more embodiments, the one or more prioritized access parameters are included in an augmented set of EDCA parameters for the data channel.

In another example embodiment, an apparatus is provided. In one or more embodiments, the apparatus comprises at least one processor and at least one memory storing instructions. In one or more embodiments, the instructions, when executed by the at least one processor, cause the apparatus to determine one or more prioritized access parameters to be utilized for data traffic that satisfies at least one priority criterion for accessing a data channel. In one or more embodiments, the instructions, when executed by the at least one processor, additionally or alternatively cause the apparatus to transmit the one or more prioritized access parameters to one or more stations associated with the data channel.

In one or more embodiments, the instructions, when executed by the at least one processor, additionally or alternatively cause the apparatus to transmit the one or more prioritized access parameters via a management frame associated with the data channel.

In one or more embodiments, the instructions, when executed by the at least one processor, additionally or alternatively cause the apparatus to determine a window for utilization of the one or more prioritized access parameters via the data channel. In one or more embodiments, the instructions, when executed by the at least one processor, additionally or alternatively cause the apparatus to transmit information associated with the window to the one or more stations associated with the data channel.

In one or more embodiments, the instructions, when executed by the at least one processor, additionally or alternatively cause the apparatus to configure the window based on one or more modification rules for reducing a contention window associated with the data traffic.

In one or more embodiments, the instructions, when executed by the at least one processor, additionally or alternatively cause the apparatus to configure the window based on one or more modification rules for increasing or decreasing a size of the window responsive to failed transmission of a data packet via at least one of the one or more stations.

In one or more embodiments, the instructions, when executed by the at least one processor, additionally or alternatively cause the apparatus to determine an interval of time for the window for utilization of the one or more prioritized access parameters via the data channel.

In one or more embodiments, the instructions, when executed by the at least one processor, additionally or alternatively cause the apparatus to determine a start position for the window based on a start position of a control frame associated with the data channel.

In one or more embodiments, the instructions, when executed by the at least one processor, additionally or alternatively cause the apparatus to determine a start position for the window based on an end position of a control frame associated with the data channel.

In one or more embodiments, the one or more prioritized access parameters comprise a prioritized access parameter associated with AIFS information for the data channel.

In one or more embodiments, the one or more prioritized access parameters additionally or alternatively comprise a prioritized access parameter associated with a contention window size for the data channel.

In one or more embodiments, the one or more prioritized access parameters additionally or alternatively comprise a prioritized access parameter associated with a transmission opportunity limit for the data channel.

In an example embodiment, a method is provided. In one or more embodiments, the method comprises determining one or more prioritized access parameters to be utilized for data traffic that satisfies at least one priority criterion for accessing a data channel. In one or more embodiments, the method additionally or alternatively comprises transmitting the one or more prioritized access parameters to one or more stations associated with the data channel.

In one or more embodiments, the method additionally or alternatively comprises transmitting the one or more prioritized access parameters via a management frame associated with the data channel.

In one or more embodiments, the method additionally or alternatively comprises determining a window for utilization of the one or more prioritized access parameters via the data channel. In one or more embodiments, the method additionally or alternatively comprises transmitting information associated with the window to the one or more stations associated with the data channel.

In one or more embodiments, the method additionally or alternatively comprises configuring the window based on one or more modification rules for reducing a contention window associated with the data traffic.

In one or more embodiments, the method additionally or alternatively comprises configuring the window based on one or more modification rules for increasing or decreasing a size of the window responsive to failed transmission of a data packet via at least one of the one or more stations.

In one or more embodiments, the method additionally or alternatively comprises determining an interval of time for the window for utilization of the one or more prioritized access parameters via the data channel.

In one or more embodiments, the method additionally or alternatively comprises determining a start position for the window based on a start position of a control frame associated with the data channel.

In one or more embodiments, the method additionally or alternatively comprises determining a start position for the window based on an end position of a control frame associated with the data channel.

In one or more embodiments, the one or more prioritized access parameters comprise a prioritized access parameter associated with AIFS information for the data channel.

In one or more embodiments, the one or more prioritized access parameters additionally or alternatively comprise a prioritized access parameter associated with a contention window size for the data channel.

In one or more embodiments, the one or more prioritized access parameters additionally or alternatively comprise a prioritized access parameter associated with a transmission opportunity limit for the data channel.

In another example embodiment, a non-transitory computer-readable storage medium is provided. In one or more embodiments, the non-transitory computer-readable storage medium includes program instructions stored thereon that are configured to determine one or more prioritized access parameters to be utilized for data traffic that satisfies at least one priority criterion for accessing a data channel. In one or more embodiments, the non-transitory computer-readable storage medium additionally or alternatively includes program instructions stored thereon that are configured to transmit the one or more prioritized access parameters to one or more stations associated with the data channel.

In one or more embodiments, the non-transitory computer-readable storage medium additionally or alternatively includes program instructions stored thereon that are configured to transmit the one or more prioritized access parameters via a management frame associated with the data channel.

In one or more embodiments, the non-transitory computer-readable storage medium additionally or alternatively includes program instructions stored thereon that are configured to determine a window for utilization of the one or more prioritized access parameters via the data channel. In one or more embodiments, the non-transitory computer-readable storage medium additionally or alternatively includes program instructions stored thereon that are configured to transmit information associated with the window to the one or more stations associated with the data channel.

In one or more embodiments, the non-transitory computer-readable storage medium additionally or alternatively includes program instructions stored thereon that are configured to configure the window based on one or more modification rules for reducing a contention window associated with the data traffic.

In one or more embodiments, the non-transitory computer-readable storage medium additionally or alternatively includes program instructions stored thereon that are configured to configure the window based on one or more modification rules for increasing or decreasing a size of the window responsive to failed transmission of a data packet via at least one of the one or more stations.

In one or more embodiments, the non-transitory computer-readable storage medium additionally or alternatively includes program instructions stored thereon that are configured to determine an interval of time for the window for utilization of the one or more prioritized access parameters via the data channel.

In one or more embodiments, the non-transitory computer-readable storage medium additionally or alternatively includes program instructions stored thereon that are configured to determine a start position for the window based on a start position of a control frame associated with the data channel.

In one or more embodiments, the non-transitory computer-readable storage medium additionally or alternatively includes program instructions stored thereon that are configured to determine a start position for the window based on an end position of a control frame associated with the data channel.

In one or more embodiments, the one or more prioritized access parameters comprise a prioritized access parameter associated with AIFS information for the data channel.

In one or more embodiments, the one or more prioritized access parameters additionally or alternatively comprise a prioritized access parameter associated with a contention window size for the data channel.

In one or more embodiments, the one or more prioritized access parameters additionally or alternatively comprise a prioritized access parameter associated with a transmission opportunity limit for the data channel.

In yet another example embodiment, an apparatus is provided. In one or more embodiments, the apparatus provides means for determining one or more prioritized access parameters to be utilized for data traffic that satisfies at least one priority criterion for accessing a data channel. In one or more embodiments, the apparatus additionally or alternatively provides means for transmitting the one or more prioritized access parameters to one or more stations associated with the data channel.

In one or more embodiments, the apparatus additionally or alternatively provides means for transmitting the one or more prioritized access parameters via a management frame associated with the data channel.

In one or more embodiments, the apparatus additionally or alternatively provides means for determining a window for utilization of the one or more prioritized access parameters via the data channel. In one or more embodiments, the apparatus additionally or alternatively provides means for transmitting information associated with the window to the one or more stations associated with the data channel.

In one or more embodiments, the apparatus additionally or alternatively provides means for configuring the window based on one or more modification rules for reducing a contention window associated with the data traffic.

In one or more embodiments, the apparatus additionally or alternatively provides means for configuring the window based on one or more modification rules for increasing or decreasing a size of the window responsive to failed transmission of a data packet via at least one of the one or more stations.

In one or more embodiments, the apparatus additionally or alternatively provides means for determining an interval of time for the window for utilization of the one or more prioritized access parameters via the data channel.

In one or more embodiments, the apparatus additionally or alternatively provides means for determining a start position for the window based on a start position of a control frame associated with the data channel.

In one or more embodiments, the apparatus additionally or alternatively provides means for determining a start position for the window based on an end position of a control frame associated with the data channel.

In one or more embodiments, the one or more prioritized access parameters comprise a prioritized access parameter associated with AIFS information for the data channel.

In one or more embodiments, the one or more prioritized access parameters additionally or alternatively comprise a prioritized access parameter associated with a contention window size for the data channel.

In one or more embodiments, the one or more prioritized access parameters additionally or alternatively comprise a prioritized access parameter associated with a transmission opportunity limit for the data channel.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 depicts an example communication system in which one or more example embodiments of the present disclosure may be performed;

FIG. 2 is a block diagram of an apparatus configured in accordance with one or more example embodiments of the present disclosure;

FIG. 3 illustrates an example signaling flow diagram in accordance with one or more example embodiments of the present disclosure;

FIG. 4 illustrates example transmissions in accordance with one or more example embodiments of the present disclosure;

FIG. 5 illustrates an example clear to send (CTS) frame in accordance with one or more example embodiments of the present disclosure;

FIG. 6 illustrates other example transmissions in accordance with one or more example embodiments of the present disclosure;

FIG. 7 illustrates other example transmissions in accordance with one or more example embodiments of the present disclosure;

FIG. 8 illustrates other example transmissions in accordance with one or more example embodiments of the present disclosure;

FIG. 9 illustrates other example transmissions in accordance with one or more example embodiments of the present disclosure;

FIG. 10 illustrates other example transmissions in accordance with one or more example embodiments of the present disclosure;

FIG. 11 illustrates other example transmissions in accordance with one or more example embodiments of the present disclosure;

FIG. 12 illustrates a flowchart illustrating operations performed, such as by the apparatus of FIG. 2, in order to enable a prioritized enhanced distributed channel access (EDCA) procedure for prioritized data traffic of a communication network, in accordance with one or more example embodiments of the present disclosure;

FIG. 13 illustrates another flowchart illustrating operations performed, such as by the apparatus of FIG. 2, in order to enable a prioritized EDCA procedure for prioritized data traffic of a communication network, in accordance with one or more other example embodiments of the present disclosure;

FIG. 14 illustrates a flowchart illustrating operations performed, such as by the apparatus of FIG. 2, in order to enable a prioritized EDCA procedure for prioritized data traffic of a communication network via a channel access window, in accordance with one or more other example embodiments of the present disclosure; and

FIG. 15 illustrates another flowchart illustrating operations performed, such as by the apparatus of FIG. 2, in order to enable a prioritized EDCA procedure for prioritized data traffic of a communication network via a channel access window, in accordance with one or more other example embodiments of the present disclosure.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means any, some or all of the following instances: (A), (B), or (A and B). For the purposes of the present disclosure, the phrase “A, B, and/or C” means any, some or all of the following instances: (A), (B), (C), (A and B), (A and C), (B and C), or (A, B, and C).

Some embodiments of the present disclosure will now be described more fully hereinafter with reference to the accompanying drawings, in which some, but not all, embodiments of the present disclosure are shown. Indeed, various embodiments of the present disclosure may be embodied in many different forms and should not be construed as limited to the certain embodiments set forth herein; rather, these certain embodiments are provided so that this disclosure will satisfy applicable legal requirements. Like reference numerals refer to like elements throughout.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the terms “data,” “content,” “information,” and similar terms may be used interchangeably to refer to data capable of being transmitted, received and/or stored in accordance with an embodiment of the present disclosure. Thus, use of any such terms should not be taken to limit the spirit and scope of one or more embodiments of the present disclosure.

A communications system may be deployed in a wireless local area network (e.g., WLAN, Wi-Fi, etc.), for example, based on IEEE 802.11 standards and/or related drafts, such as 802.11-2020, 802.11ac, 802.11ax, 802.11be, 802.11bn, and/or others. That is, the system may be an example of a WLAN system. The WLAN system may support wireless communications between one or more communications devices in accordance with one or more Wi-Fi protocols. In some examples, Wi-Fi communications may occur via one or more radio frequency bands, such as about a 2.4 GHz radio frequency band, a 5 GHz radio frequency band, a 6 GHz radio frequency band, and/or another radio frequency band. In some such examples, each radio frequency band may support one or more channels over which data may be communicated. In some examples, multiple devices may use multiple channels to communicate over the WLAN simultaneously.

A WLAN system may include one or more communications devices, such as one or more access points (APs) and/or one or more non-AP stations (STAs). That is, a device configured to support one or more Wi-Fi protocols may be an example of an AP (e.g., may operate in accordance with an AP mode) and/or may be an example of a STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more non-AP STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID).

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity which may be configured to act as a network manager. In some examples, the network manager is an entity in cloud-based entity which may reside either in private cloud or in public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients (e.g., STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more non-AP STAs (also referred to as clients) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs, may communicate wirelessly with one or more other APs.

In accordance with one or more Wi-Fi protocols, data may be transmitted wirelessly between two devices (e.g., an AP and a non-AP STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDUs, wherein a payload of a PDU may comprise user data, control data, management data, and/or other data. In some examples, a WLAN system may implement one or more security protocols to protect the confidentiality, integrity, and availability of Wi-Fi communications.

A WLAN system may be configured with various types of services sets, for example, such as basic service set (BSS) and/or an extended service set (ESS). A BSS may be comprised of an AP and one or more client devices (e.g., non-AP STAs) associated with the AP. The one or more client devices may have one or more common PHY medium access characteristics (e.g., radio frequency, modulation scheme, security settings, and/or the like). A BSS identifier (BSSID) may define the BSS such that the one or more client devices of the BSS share the same BSSID.

A communication network such as a WLAN may support latency-sensitive applications at Wi-Fi stations (STAs). Such latency-sensitive applications may include virtual reality (VR) applications, mixed reality (MR) applications, augmented reality (AR) applications, and extended reality (XR) applications. Latency-sensitive applications may also include applications that utilize sensors which detect events to be reported with low latency. However, in some cases, default procedures for channel access of a communication network (e.g., a WLAN) may constrain performance of the latency-sensitive applications and/or the communication network. For example, low latency support may involve delivering frames with low latency for APs and non-AP STAs. To support low latency traffic, a channel access procedure for a communication network may be modified to provide higher priority access to STA(s) with low latency traffic. As an example, some Wi-Fi devices utilize a Carrier Sense Multiple Access with Collision Avoidance (CSMA/CA) protocol which relies on a backoff mechanism to manage access to a shared wireless channel. In some examples, a contention window (CW) may be utilized to support low latency traffic. For instance, when multiple devices request to transmit data at the same time, each device may select a random backoff time from a defined range called the contention window. Typically, for each access category (AC) there is a minimum Contention Window (CW_min) and a maximum Contention Window (CW_max). For example, Access Category Voice (AC_VO) may be the highest priority access category and the CW_min may be set to ¼th of CW_min for best effort traffic associated with data traffic where priority is not critical (e.g., web browsing, email, etc.) or background traffic associated with data traffic for low-priority background tasks (e.g., downloading content, etc.). In other examples, exponential backoff may be utilized. For instance, if a collision occurs (e.g., multiple devices transmit simultaneously), the contention window size may be increased exponentially (e.g., increased by 2× until CW_max is reached) for each subsequent transmission attempt, thereby providing more time for other devices to transmit data and reducing the likelihood of further collisions. In other examples, randomization may be utilized. For instance, the random selection of the backoff time within the contention window may be utilized to minimize synchronized transmission attempts from multiple devices, further preventing collisions.

In some examples, a communication network such as a WLAN may utilize an enhanced distributed channel access (EDCA) procedure to support low latency traffic. For example, an EDCA procedure may be utilized to provide preferential wireless channel access for voice data, video data, and/or other quality of service (QoS) data associated with low latency applications. Current EDCA procedures enables an advantage to Access Category Voice (AC_VO) traffic by setting the CW_min and CW_max value to a lower value compared to other data traffic such as Access Category Video (AC_VI) traffic, Access Category Best Effort (AC_BE) traffic, and Access Category Background (AC_BK) traffic. However, if a transmission is not successful, a STA typically increases the contention window size by a factor of two. However, for low latency traffic, the exponential increase in contention window size provides a disadvantage to a low latency STA that experiences failed transmissions due to for example collisions of sent packets as compared to other STAs which may include another type of data traffic, thereby increasing experienced tail latency associated with the communication network. As such, it may be desirable to improve current EDCA procedures to enable a STA with prioritized data traffic such as low latency traffic to obtain prioritized access to a data channel of a communication network.

Described herein are apparatuses, methods, and computer program products for enabling a prioritized EDCA procedure for prioritized data traffic of a communication network to resolve some or all of the described limitations of current communication networks and/or current network protocols. For example, the prioritized EDCA procedure disclosed herein may enable a STA with low-latency data traffic to obtain prioritized access to a data channel of a communication network as compared to one or more other STAs associated with another type of data traffic. In some embodiments, prioritized data traffic (e.g., low-latency data traffic) may be associated with a particular type of application such as a virtual reality application, a mixed reality application, an augmented reality application, and/or an extended reality application. The prioritized EDCA procedure disclosed herein may enhance a prioritized traffic exchange using EDCA. In some embodiments, the prioritized EDCA procedure disclosed herein may enhance a prioritized traffic exchange using EDCA during a channel access window. In some embodiments, the channel access window may be an enhanced version of a contention window that is defined for a data channel according to IEEE 802.11

In some embodiments, an access point may utilize the prioritized EDCA procedure to announce one or more prioritized access parameters for one or more STAs based on the data traffic to be transmitted by the one or more STAs such that one or more prioritized access parameters may be utilized when prioritized data traffic is to be transmitted. In some embodiments, the one or more prioritized access parameters may be included in an augmented set of EDCA parameters. In some embodiments, the prioritized EDCA procedure may utilize a channel access window (e.g., a high priority EDCA window) for a data channel. With the channel access window, prioritized data traffic such as low-latency data traffic or other prioritized data traffic may be prioritized over non-prioritized data traffic (e.g., non-low-latency data traffic). In some embodiments, the channel access window may be a modified contention window with a reduced length as compared to a contention window for non-prioritized data traffic.

In some embodiments, channel access contention among STAs may be controlled and/or managed by announcing one or more prioritized access parameters for a channel access window during which STAs perform EDCA channel access. In some embodiments, the one or more prioritized access parameters may restrict a duration of an initial frame that a STA can send after capturing a data channel via an EDCA function, restrict a type of initial frame that a STA can send after capturing a data channel via an EDCA function, restrict a maximum channel duration that can be reserved by an initial frame sent by a STA after capturing a data channel via an EDCA function, and/or restrict the number of frames that a STA can send after capturing a data channel via an EDCA function. The restrictions may be applied to one or more particular time periods, access categories, traffic identifier, and/or or traffic streams. In some embodiments, the restrictions may be applied to one or more particular STAs associated with one or more predefined conditions such as a condition where a STA experiences excessive collisions or a condition where a STA experiences excessive delays.

Accordingly, with the prioritized EDCA procedure for prioritized data traffic disclosed herein, resource utilization associated with a communication network may be improved and/or latency associated with a data channel may be reduced, thereby improving performance of STAs and/or latency-sensitive applications. The prioritized EDCA procedure for prioritized data traffic disclosed herein may also provide improved performance, accuracy, and/or functionality for an access point associated with a communication network. In various embodiments, a number of computing resources and/or processing tasks for a STA to access and/or utilize a data channel of communication network can be reduced. Efficiency and/or network connectivity for a communication network can also be improved. For example, overall network signaling and/or data load of a data channel can be reduced to provide improved resiliency, network latency, and/or network speeds provided by a communication network. Moreover, tail latency associated with a communication network may also be minimized by utilizing the prioritized EDCA procedure for prioritized data traffic disclosed herein.

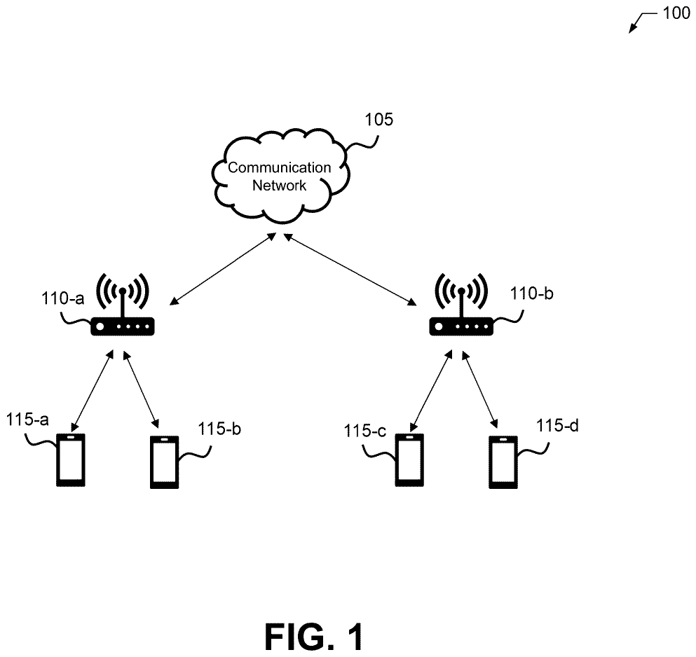

Referring now to FIG. 1, an example communication system 100 is illustrated according to one or more embodiments of the present disclosure. The communication system 100 is a communication system to which one or more examples disclosed herein may be applied. The depiction of the communication system 100 in FIG. 1 is not intended to limit or otherwise confine the example embodiment described and contemplated herein to any particular configuration of elements or systems, nor is it intended to exclude any alternative configurations or systems for the set of configurations and systems that can be used in connection with an example embodiment of the present disclosure. Rather, FIG. 1, and the communication system 100 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

The communication system 100 includes a communication network 105, one or more access points (APs) 110 (e.g., an AP 110a and an AP 110-b), and one or more stations (STAs) 115 (e.g., STA 115-a, STA 115-b, STA 115-c, and STA 115-d). The communication system 100 is a type of network where at least one link is wireless, and provides voice, video, and/or data services to a plurality of devices. The communication network 105 may be a wireless communication network, a wireless local area network, a Wi-Fi network, or another type of communication network. The communication network 105 is illustrated as providing communication services to the one or more STA 115 via the one or more APs 110. The one or more STA 115 may be enabled for voice services, video services, data services, VR services, MR services, AR services, XR services, Internet of Things (IoT) services, and/or one or more other services. In some embodiments, the communication network 100 or components thereof can be configured to communicate with the one or more STA 115 and/or the one or more APs 110 over multiple different frequency bands, sub-bands thereof, and/or the like.

The one or more STAs 115 may be one or more client devices, such as one or more non-AP STAs, connected to the one or more APs 110. For example, the STA 115-a and the STA 115-b may be connected to the AP 110-a. Additionally, the STA 115-c and the STA 115-d may be connected to the AP 110-b. In some examples, the one or more APs 110 may be mobile access points (mAPs) with controlled network functionality. In such examples, a configuration comprising a mAP and a STA may be implemented based on Wi-Fi Direct or another type of network connection. In some examples, a device may simultaneously operate as a non-AP STA and as an AP. One such an example case is in a multi-AP network, which includes two or more devices that may act as APs and use Wi-Fi for the wireless backhaul connectivity based on a non-AP STA-AP connection model. In some examples, a device may simultaneously operate as part of a peer-to-peer connection based on Wi-Fi Direct or Wi-Fi Aware.

In some embodiments, communication between the one or more STAs 115 and the one or more APs 110 may provide the one or more STAs 115 access to the communication network 105 and/or may enable communication therewith. In some embodiments, the one or more APs 110 may provide wireless connectivity for the one or more STAs 115 according to the Wi-Fi standards, such as those that are a subset of the IEEE 802 family of standards. For example, the one or more APs 110 may provide wireless connectivity for the one or more STAs 115 according to the MAC and PHY specifications for Wi-Fi access points defined by IEEE 802.11 for transmitting and receiving data in frequency bands such as 2.4 GHz, 3.6 GHz, 5 GHz, 6 GHz, 60 GHz, and/or the like. The one or more APs 110 and the one or more STAs 115 may communicate through the transmission of frames, including data frames, beacon frames, management frames, and/or control frames, which may be transmitted in unicast messages, broadcast messages, or multicast messages. The 802.11 standards define an inter-frame space (IFS) as the nominal time (in microseconds (μs)) that the MAC and PHY use to receive the last symbol of a frame, process the frame, and respond with the first symbol of a response frame (e.g., the earliest possible response frame). In some embodiments, one or more STAs 115 may be configured to be in a wireless connection with at least one Wi-Fi AP (e.g., AP 110). It is to be appreciated that a Wi-Fi AP may be implemented by various entities and/or types of entities, for example, such as APs, mAPs, access nodes, nodes, hosts, servers, base stations, and/or other entities suitable for such usage.

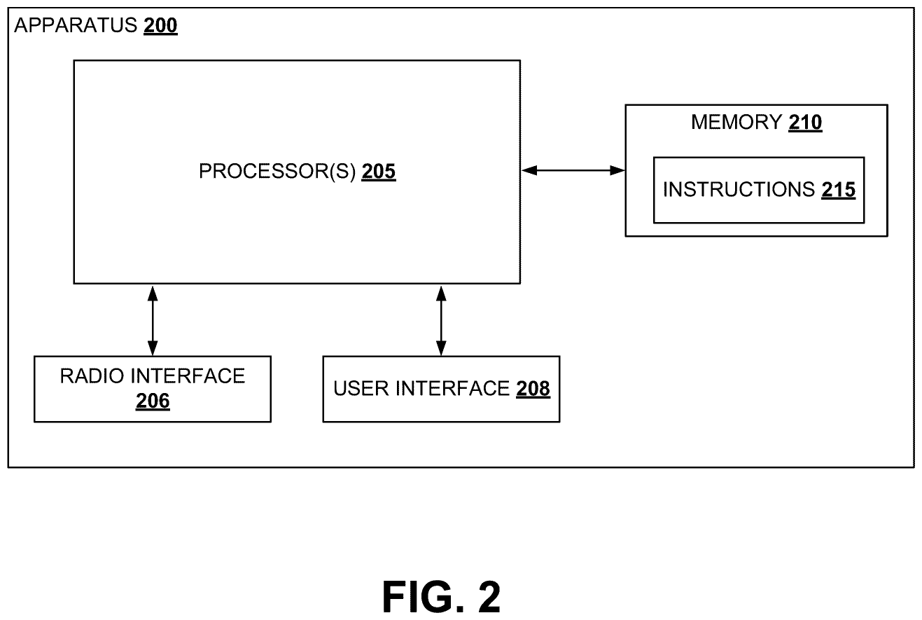

In some examples, the communication system 100 may support radio frequency sensing during IFS. In some examples, the communication system 100 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. In some embodiments, the transceiver may include a processor and/or a memory (e.g., such as processor 205 and/or memory 210, further described with respect to FIG. 2). The processor 205 may be used to execute instructions stored in the memory 210 and/or to store information in the memory 210, for example, such as the results of the executed instructions.

The one or more APs 110 may include transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver. In some embodiments, the transceiver of an AP 110 may include a processor and/or a memory (e.g., such as processor 205 and/or memory 210, further described with respect to FIG. 2).

An STA of the one or more STAs 115 may be a client device such as, for example, a client-side user device, a non-AP STA, user equipment (UE), and/or another type of entity configured to communicate with the one or more APs 110. A UE may be a mobile terminal, such as a mobile phone, a smartphone, a pager, a mobile television, a gaming device, a laptop computer, a computer with a mobile broadband adapter, a camera, a tablet computer, a portable digital assistant (PDA), a communicator, pad, a wearable device, a headset, a touch surface, a video recorder, an audio/video player, radio, an electronic book, a positioning device (e.g., global positioning system (GPS) device), a virtual reality device, an augmented reality device, or any combination of the aforementioned. In some embodiments, an AP 110 may include a processor and/or a memory (e.g., such as processor 205 and/or memory 210, further described with respect to FIG. 2).

In some embodiments, the communication system 100 may support latency-sensitive applications at Wi-Fi devices such as the one or more APs 110 and the one or more STAs 115. Such latency-sensitive applications may include virtual reality applications, mixed reality applications, augmented reality applications, and extended reality applications.

In one or more embodiments, an EDCA procedure for prioritized data traffic associated with the communication system 100 and/or the communication network 105 may be enabled by employing an apparatus 200 as depicted in FIG. 2. The apparatus 200 may be embodied by and/or incorporated into an AP (e.g., the one or more APs 110), an STA (e.g., the one or more STAs 115), and/or another device discussed with respect to FIG. 1.

Regardless of the manner in which the apparatus 200 is embodied, the apparatus 200 includes, is associated with, and/or is in communication with: at least one processor 205, at least one memory 210, and a communication interface 215. In one or more embodiments, the apparatus 200 comprises, for example, the at least one processor 205 and the at least one memory 210 storing instructions 215 that, when executed by the at least one processor 205, cause the apparatus 200 at least to perform the method or methods as disclosed herein, and any of the embodiments thereof. In an example, the at least one memory 210 and the instructions 215 (e.g., a computer program code, software), are configured, with the at least one processor 205, to cause the apparatus 200 to perform the method or methods as disclosed herein, and any of the embodiments thereof.

In some embodiments, the processor 205 may be in communication with the memory 210 via a bus for passing information among components of the apparatus 200. The memory 210 may be non-transitory and may include, for example, one or more volatile and/or non-volatile memories. In other words, for example, the memory 210 may be an electronic storage device (e.g., a computer readable storage medium) comprising gates configured to store data (e.g., bits) that may be retrievable by a machine (e.g., a computing device like the processor). The memory 210 may be configured to store information, data, content, applications, instructions, or the like for enabling the apparatus to carry out various functions in accordance with an example embodiment of the present disclosure. For example, the memory 210 could be configured to buffer input data for processing by the processor. Additionally or alternatively, the memory 210 may be configured to store instructions for execution by the processor 205.

The processor 202 may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 210 may be implemented using any suitable data storage technology. The memory may comprise a database for storing data. The memory 210 may be at least in part external to apparatus 200 but accessible to apparatus 200.

The instructions 215 may be comprised in a computer readable medium or a non-transitory computer readable medium. A term non-transitory, as used herein, is a limitation of the medium itself (e.g., tangible, not a signal) as opposed to a limitation on data storage persistency (e.g., random access memory, RAM, vs. read only memory, ROM).

The apparatus 200 comprises a radio interface 206. The radio interface 206 may provide the apparatus 200 with communication capabilities. The radio interface 206 may comprise a receiver configured to receive information in accordance with at least one cellular or non-cellular standard. The radio interface 206 may comprise a transmitter configured to transmit information in accordance with at least one cellular or non-cellular standard. The receiver may comprise more than one receiver. The transmitter may comprise more than one transmitter. The radio interface 206 may comprise a transceiver configured to receive and transmit information in accordance with at least one cellular or non-cellular standard. The transceiver may comprise more than one transceiver.

The apparatus 200 may optionally comprise a user interface 208 comprising, for example, at least one of a keypad, a microphone, a touch display, a display, a speaker, etc. The user interface 208 may be used to control the apparatus by the user. The user interface 208 may be external to the apparatus 200. For example, the apparatus 200 may be connected to another device, such as a computer, either via wireless or wired connection, and the apparatus 200 is controlled by the user via the computer.

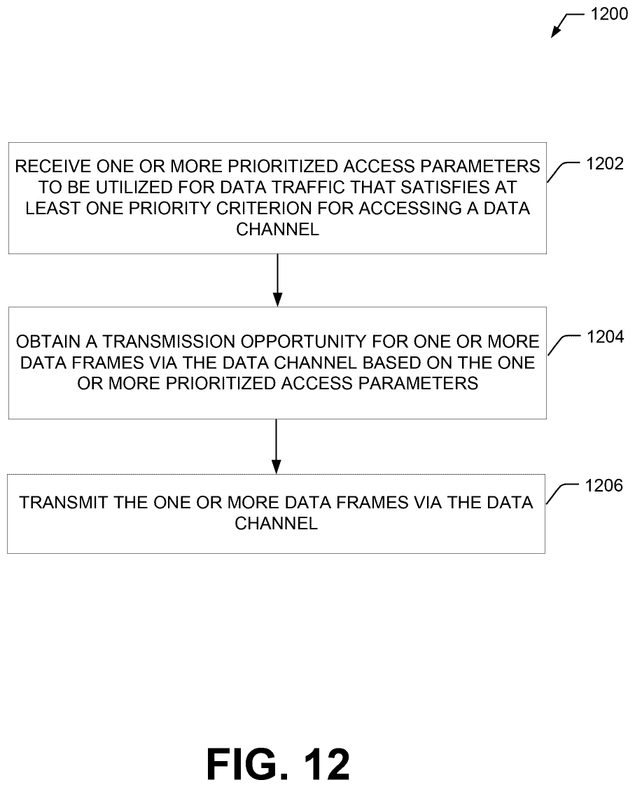

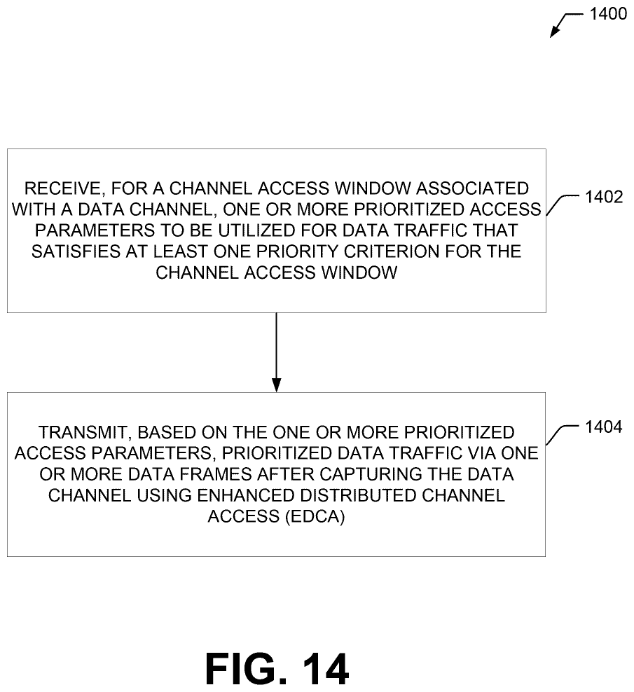

The apparatus 200 may be embodied by or otherwise associated with a station, e.g., a user equipment or other client device. In another embodiment, the apparatus is comprised in such a station, e.g. as a chipset configured to control the station. The apparatus 200 embodied by or otherwise associated with a station may be caused or configured to perform at least the method of FIG. 12, FIG. 14, and/or any one or more of the embodiments described.

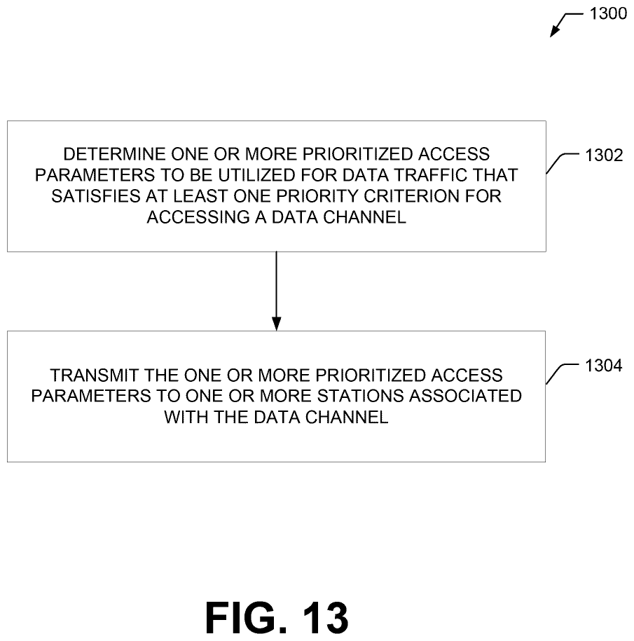

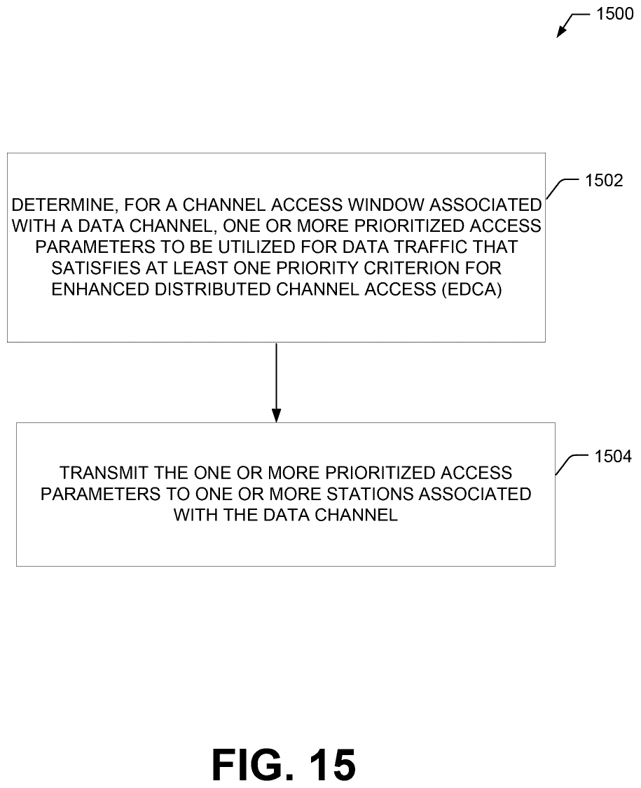

Alternatively, the apparatus 200 may be embodied by or otherwise associated with an access point. As another example, the apparatus is comprised in such an access point, e.g. as a chipset configured to control the access point. The apparatus 200 embodied by or otherwise associated with an access point may be caused or configured to perform at least the method of FIG. 13, FIG. 15, and/or any one or more of the embodiments described.

In an embodiment, at least some of the processes described herein may be carried out by an apparatus comprising means for carrying out at least some of the described processes. Means for performing method steps as disclosed herein may include software and/or hardware components of the apparatus 200. For example, the at least one processor 205, the memory 210, and instructions, such as for example the computer program code form means for carrying out the method or methods as disclosed herein, and any of the embodiments thereof. As used herein the term “means” is to be construed in singular form, e.g., referring to a single element, or in plural form, e.g., referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

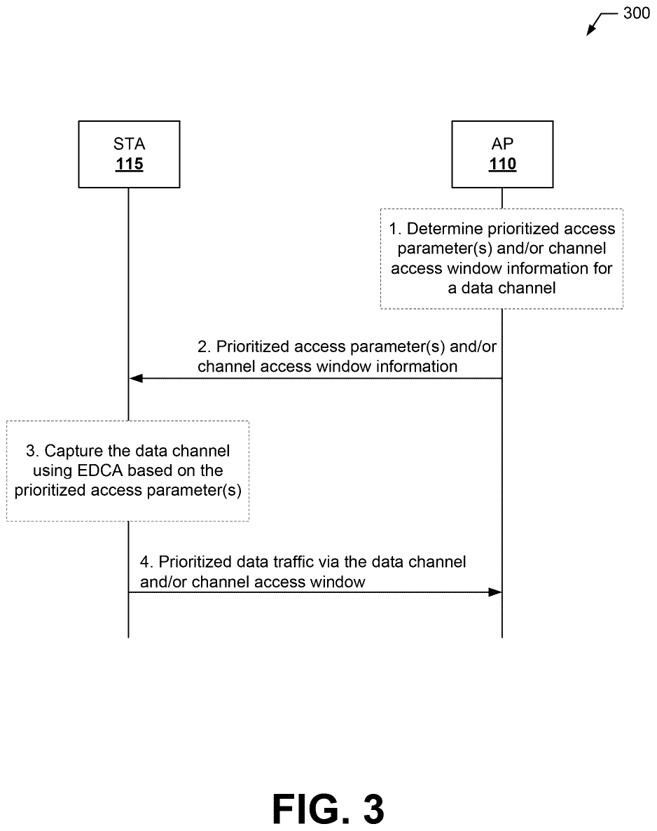

FIG. 3 illustrates example transmissions between STA 115 and AP 110 for enabling an enhanced EDCA procedure for prioritized data traffic associated with a communication network (e.g., the communication network 105), according to one or more embodiments. The below example transmissions provide the foreseen steps, network signals, and/or messaging to enable the STA 115 to transmit prioritized data traffic via a data channel of the communication network and/or a channel access window associated with the data channel. In some embodiments, the channel access window may be an enhanced version of a contention window that is defined for the data channel according to IEEE 802.11.

In some embodiments, the AP 110 determines prioritized access parameter(s) and/or channel access window information for a data channel, at 1. For example, the AP 110 may determine one or more prioritized access parameters to be utilized for data traffic that satisfies at least one priority criterion for accessing a data channel. In some embodiments, the one or more prioritized access parameters may be included in an augmented set of EDCA parameters for the data channel. In some embodiments, the one or more prioritized access parameters include a prioritized access parameter associated with arbitration inter-frame spacing (AIFS) information for the data channel, a prioritized access parameter associated with a channel access window size for the data channel, a prioritized access parameter associated with a transmission opportunity limit for the data channel, and/or one or more other types of prioritized access parameters to be utilized for data traffic that satisfies the at least one priority criterion for accessing the data channel. In some embodiments, the at least one priority criterion may be based on an indication that the data traffic is associated with low-latency data traffic. Additionally or alternatively, the at least one priority criterion may be based on an indication that the data traffic is associated with a particular type of application such as, for example, a virtual reality application, a mixed reality application, and/or an extended reality application. In some embodiments, the AP 110 may determine the one or more prioritized access parameters based upon a Buffer Status Report (BSR), a Stream Classification Service (SCS) setup, and/or another type of data associated with the data channel. In some embodiments, the AP 110 may negotiate the one or more prioritized access parameters with the STA 115. In some embodiments, the AP 110 may predict a number of STAs that will request transmission of prioritized data traffic for the data channel. Additionally, the AP 110 may determine the channel access window information based on the predicted number of STAs. For example, the AP 110 may determine the one or more prioritized access parameters based on quality-of-service information and/or stream classification service information for data traffic associated with STAs and/or the data channel.

In some embodiments, the access window information may be associated with a channel access window for the data channel. The channel access window may be a window for utilization of the one or more prioritized access parameters via the data channel. In some embodiments, the channel access window is a high-priority EDCA window for the data channel. The channel access window information may include one or more settings and/or configuration parameters for the channel access window associated with the data channel. For example, the channel access window information may include a length, a start position, and/or other information regarding the channel access window associated with the data channel. In some embodiments, the AP 110 may determine the length (e.g., an interval of time) for the channel access window for utilization of the one or more prioritized access parameters via the data channel. In some embodiments, the AP 110 may additionally or alternatively determine the start position for the channel access window based on a start position of a control frame associated with the data channel. In some embodiments, the AP 110 may additionally or alternatively determine the start position for the channel access window based on an end position of a control frame associated with the data channel. In some embodiments, the AP 110 may configure the one or more prioritized access parameters for the channel access window such that a default ECDA procedure is utilized by the STA 115 outside the channel access window.

In some embodiments, the AP 110 may configure the channel access window based on one or more modification rules for reducing a window defined for a data channel associated with the data traffic. For example, the one or more modification rules may be related to reducing a length, modifying a starting position, modifying an ending position, and/or one or more other configuration parameters associated with the channel access window. In some embodiments, the AP 110 may configure the channel access window to coincide with a start of a control frame or an end of a control frame that includes information regarding a duration of the channel access window.

In some embodiments, the one or more modification rules may be related to adapting a backoff procedure for the channel access window. In some embodiments, the one or more modification rules may increase and/or decrease a length of the channel access window based on a failed transmission (e.g., a collision) associated with the data channel and/or the STA 115. Additionally or alternatively, the one or more modification rules may increase and/or decrease a rate of transmission for the data channel and/or the STA 115 based on a failed transmission (e.g., a collision) associated with the data channel and/or the STA 115. In some embodiments, the rate of transmission may refer to how often the channel access window is scheduled for the data channel. In an example, the one or more modification rules may enable the AP 110 and/or the STA 115 to increase the channel access window when experiencing a failed transmission (e.g., a collision) for a define number of times and then decreasing the channel access window responsive to the failed transmission occurring again a defined number of times. In some embodiments, the one or more modification rules may enable the AP 110 and/or the STA 115 to increase a contention window that is defined for the data channel according to IEEE 802.11 when experiencing a failed transmission (e.g., a collision) for a define number of times and then decreasing the contention window responsive to the failed transmission occurring again a defined number of times. In another example, the one or more modification rules may enable the AP 110 and/or the STA 115 to begin access to the data channel with a particular length for the channel access window and, responsive to experiencing a failed transmission (e.g., collision), maintain the particular length for a defined number of attempts and then decrease the length of the channel access window after the defined number of attempts. In another example, the one or more modification rules may enable the AP 110 and/or the STA 115 to begin access to the data channel with a particular length for the channel access window and, responsive to experiencing a failed transmission (e.g., collision), decrease the length of the channel access window. In another example, the one or more modification rules may enable the AP 110 and/or the STA 115 to begin access to the data channel with a particular length for the channel access window and, responsive to a higher value being reached due to a failed transmission (e.g., collision), reset the length of the channel access window to a minimum value after a defined number of times before the length of the channel access window is increased again. In some embodiments, a condition upon which the channel access window is modified by the AP 110 is based on a congestion indication from a higher layer of the communication network 105 or a combination of the congestion indication and a failed transmission by an STA.

In some embodiments, the channel access window information may include dynamic restrictions related to frame duration, frame type, channel reservation duration, a number of frames that are transmitted during a channel access window, and/or one or more other data channel configurations. For example, the AP 110 may determine, for the channel access window associated with the data channel, one or more prioritized access parameters to be utilized for data traffic that satisfies at least one priority criterion for EDCA. In some embodiments, the AP 110 may determine a frame type parameter indicative of a type of data frame that is permissible for transmitted after the capturing of the data channel using the EDCA. As used herein, the phrase “permissible for transmission” when referred to an element, such as for example a data frame, is to be understood to mean that such element has obtained permission for being transmitted. In some embodiments, the AP 110 may additionally or alternatively determine a frame duration parameter indicative of a maximum permissible duration for a first data frame that is permissible for transmission after the capturing of the data channel using the EDCA. In some embodiments, the AP 110 may additionally or alternatively determine a channel reservation duration parameter indicative of a maximum amount of time a station is permitted to reserve the data channel after the capturing of the data channel using the EDCA. In some embodiments, the AP 110 may additionally or alternatively determine a frame number parameter indicative of a maximum number of frames a station is permitted to transmit after the capturing of the data channel using the EDCA. In some embodiments, the AP 110 may additionally or alternatively determine a data channel parameter indicative of a maximum number of times the apparatus is permitted to capture the data channel using the EDCA during the channel access window. As such, in some embodiments, the one or more prioritized access parameters may include the frame type parameter, the frame duration parameter, the channel reservation duration parameter, the frame number parameter, the data channel parameter, and/or one or more other prioritized access parameters.

In some embodiments, the one or more prioritized access parameters are associated with a first sub-window of the channel access window. Additionally, the AP 110 may determine one or more different prioritized access parameters for at least a second sub-window of the channel access window. In some embodiments, the one or more prioritized access parameters are associated with a first access category for the channel access window. Additionally, the AP 110 may determine one or more different prioritized access parameters for at least a second access category for the channel access window. In some embodiments, the one or more prioritized access parameters are associated with a first data stream type associated with the data channel. Additionally, the AP 110 may additionally or alternatively determine one or more different priority access parameters for at least a second data stream type associated with the data channel.

In some embodiments, the AP 110 transmits the prioritized access parameter(s) and/or channel access window information to the STA 115, at 2. For example, the AP 110 may transmit the one or more prioritized access parameters to the STA 115 and/or one or more other STAs associated with the data channel. In some embodiments, the AP 110 may transmit the one or more prioritized access parameters to the STA 115 and/or one or more other STAs via a management frame such as a defined signaling frame, a probe response frame, a beacon frame, or another type of management frame. In some embodiments, the AP 110 may repeatedly transmit the one or more prioritized access parameters to the STA 115 and/or one or more other STAs via a beacon frame. In some embodiments, the one or more prioritized access parameters may be included in a dedicated information element or field information for the management frame. In some embodiments, the AP 110 may transmit the one or more prioritized access parameters to the STA 115 and/or one or more other STAs via a control frame such as a clear to send (CTS) frame or another type of control frame. As such, the STA 115 and/or one or more other STAs may receive the one or more prioritized access parameters to be utilized for data traffic that satisfies at least one priority criterion for accessing the data channel managed by the AP 110.

In some embodiments, the AP 110 may provide authorization to the STA 115 and/or one or more other STAs to utilize the one or more prioritized access parameters via a trigger frame, an initial control frame, or another type of frame. In some embodiments, the AP 110 may provide authorization to the STA 115 and/or one or more other STAs to utilize the one or more prioritized access parameters via an MU-RTS trigger frame. In some embodiments, the AP 110 may provide authorization to the STA 115 and/or one or more other STAs responsive to determining that data traffic and/or conditions associated with the STA 115 and/or one or more other STAs satisfies authorization criterion for the data channel.

In some embodiments, the STA 115 captures the data channel using EDCA based on the prioritized access parameter(s), at 3. For example, the STA 115 may obtain a transmission opportunity for one or more data frames via the data channel based on the one or more prioritized access parameters. In some embodiments, the STA 115 may determine whether or not to utilize the one or more prioritized access parameters for the transmission opportunity. In some embodiments, the AP 110 may mandate that the STA 115 utilizes the one or more prioritized access parameters for the transmission opportunity. In some embodiments, the STA 115 may obtain the transmission opportunity for a channel access window associated with the data channel.

In some embodiments, the STA 115 transmits prioritized data traffic via the data channel and/or channel access window, at 4. For example, the STA 115 may transmit the one or more data frames via the data channel. In some embodiments, the STA 115 may transmit prioritized data traffic via the one or more data frames after capturing the data channel using EDCA based on the one or more prioritized access parameters.

In some embodiments, if the size or type of the data to be transmitted by the STA 115 results in a frame duration that is shorter than a maximum specified by the one or more prioritized access parameters, the STA 115 may proceed to send a data frame directly without utilizing RTS/CTS. In some embodiments, the data frame may be a data frame or a QoS Null data frame carrying buffer status information of the STA 115. On the other hand, if the size of the data and the selected MCS results in a frame duration that exceeds the permitted maximum duration specified by the one or more prioritized access parameters, the STA 115 may utilize RTS/CTS or fragment the data frame so that the duration of the first frame sent is equal to or less than the maximum allowed frame duration. In some embodiments, the AP 110 may terminate an authorization for the STA 115 by informing the STA 115 or a group of STAs that includes the STA 115. The authorization termination information may be provided through a dedicated frame or via a beacon frame, probe frame, association frame, or another management frame within a dedicated information element or field information. Upon receiving such information, the STA 115 may return to using a legacy set of EDCA parameters for capturing the data channel.

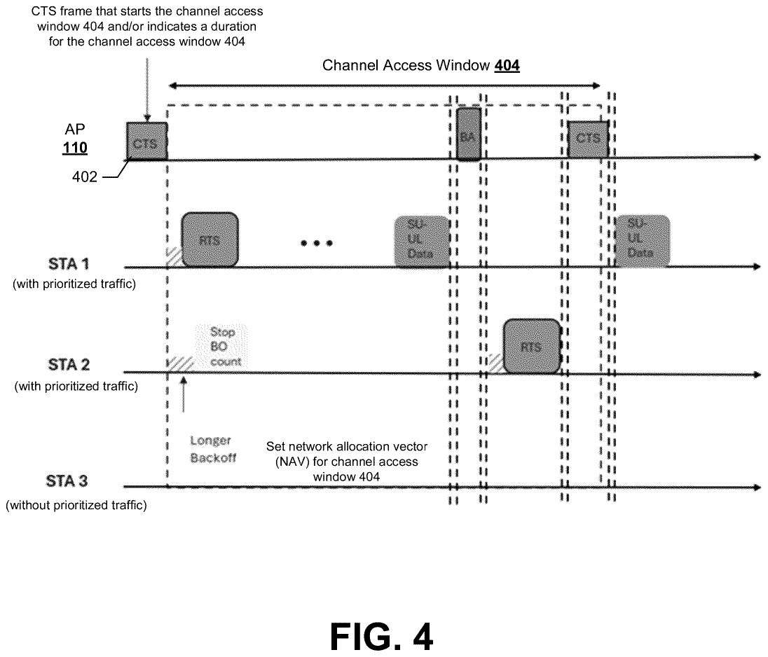

FIG. 4 illustrates example transmissions associated with AP 110 and one or more STAs, according to one or more embodiments. In some embodiments, a CTS frame 402 begins a channel access window 404 such that a non-AP STA with LL traffic may contend for channel access with other non-AP STAs with similar traffic. In some embodiments, the AP 110 may transmit a management frame to indicate the one or more prioritized access parameters to STA 1, STA 2, and/or STA 3 such that prioritized data traffic associated with the STA 1, STA 2, and/or STA 3 may be transmitted via the channel access window 404.

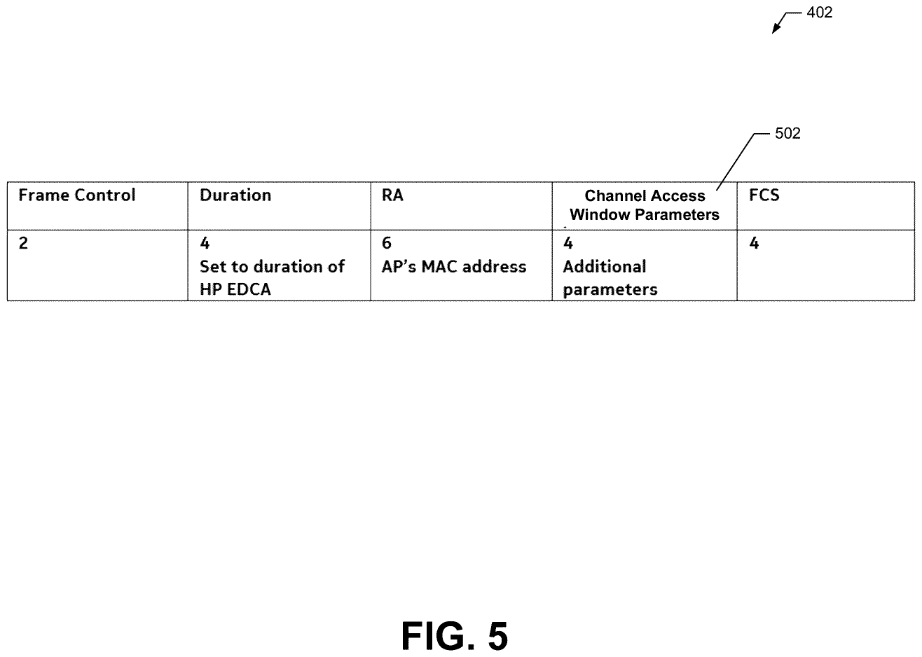

FIG. 5 illustrates example format for the CTS frame 402, according to one or more embodiments. In some embodiments, the CTS frame 402 may be augmented to incorporate a channel access window data field for channel access window parameters associated with the channel access window 404 in addition to a data field associated with frame control, duration, receiver address, and/or a frame check sequence.

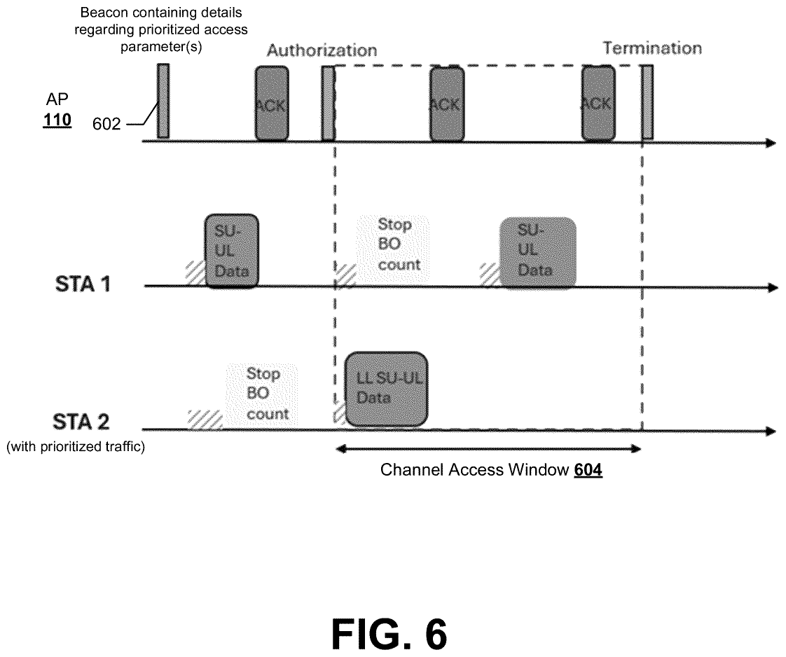

FIG. 6 illustrates example transmissions associated with AP 110 and one or more STAs, according to one or more embodiments. In some embodiments, a beacon frame 602 or another type of management frame is transmitted by the AP 110 to indicate the one or more prioritized access parameters for STA 1 and STA 2. In some embodiments, the beacon frame 602 may indicate that the one or more prioritized access parameters may be utilized to access a data channel during a channel access window 604. As such, the AP 110 may transmit the beacon frame 602 to indicate the one or more prioritized access parameters to STA 1 and STA 2 such that prioritized data traffic associated with the STA 1 and/or STA 2 may be transmitted via the channel access window 604. In some embodiments, upon receiving an authorization from an AP to use the one or more prioritized access parameters, STA 2 associated with low-latency data for transmission via the data channel may begin more aggressively contending the data channel and due to, for example, a lower channel access window that is to go through to assess that the data channel is idle such that the STA 2 is able to acquire the data channel with high frequency and more likelihood than STA 1.

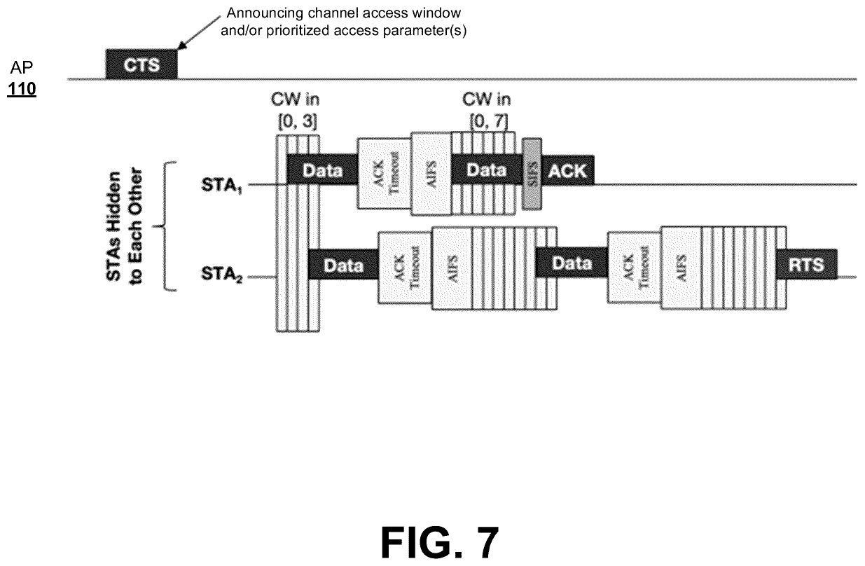

FIG. 7 illustrates example transmissions associated with AP 110 and one or more STAs, according to one or more embodiments. In some embodiments, by transmitting the one or more prioritized access parameters and/or the channel access window information to one more STAs, a probability of collisions associated with the data channel may be minimized when an STA is hidden from other STAs. For example, as illustrated in FIG. 7, STA 1 and STA 2 may be hidden from each other. Additionally, the AP 110 may enforce smaller frame durations for the channel access window such that a second frame sent by STA 1 does not experience a collision.

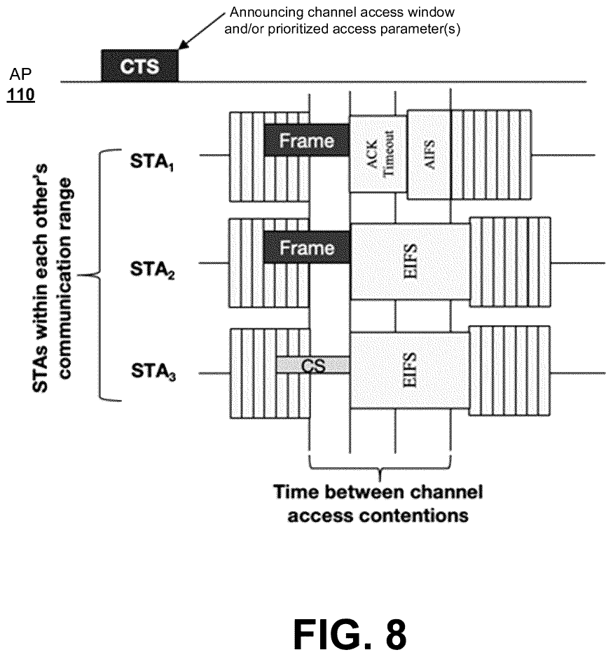

FIG. 8 illustrates example transmissions associated with AP 110 and one or more STAs, according to one or more embodiments. In some embodiments, by transmitting the one or more prioritized access parameters and/or the channel access window information to one more STAs, more active channel access contention may be realized by reducing an interval between EDCA channel access instances. For example, as illustrated in FIG. 8, STAs may be configured to identify transmissions from other STAs. As an example, STA 1 and STA 2 may select the same time slot such that respective frames from the STA 1 and STA 2 may collide. However, since shorter frame durations are used, STAs can more actively perform channel access contention, thereby reducing latency of the data channel.

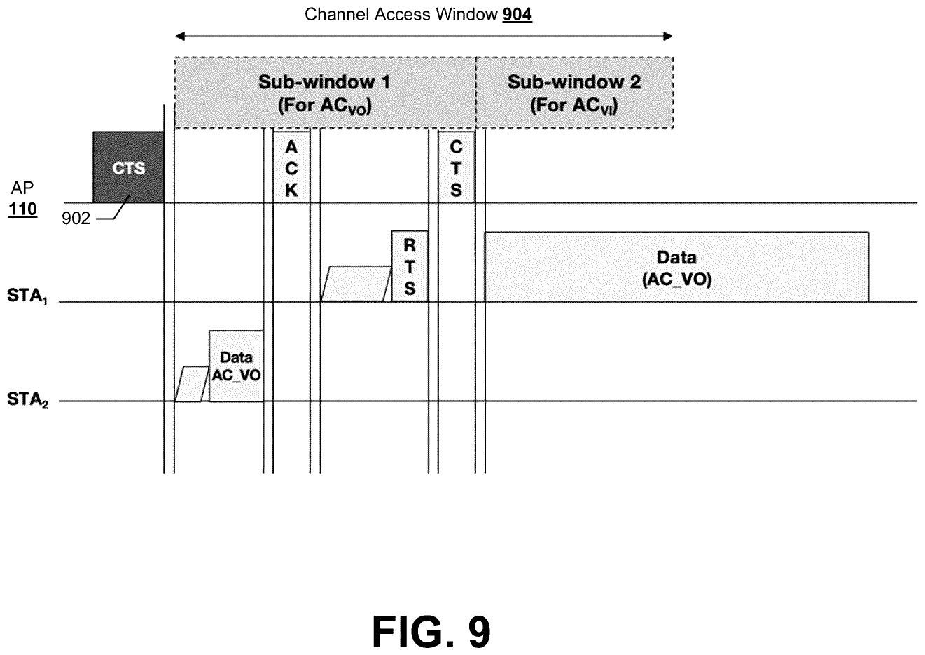

FIG. 9 illustrates example transmissions associated with AP 110 and one or more STAs, according to one or more embodiments. In some embodiments, the one or more prioritized access parameters and/or the channel access window information provided by the AP 110 may be applied to specific channel access sub-windows (e.g., sub-periods of a channel access window), access categories, STAs, and/or data traffic streams. For example, as illustrated in FIG. 9, the one or more prioritized access parameters and/or the channel access window information may be applied to a channel access window 904 divided into sub-windows (e.g., sub-window 1 and sub-window 2).

In some embodiments, the AP 110 may broadcast (1) a structure for a channel access window, where the channel access window is divided into sub-windows and each sub-window is associated with a traffic access category and/or (2) parameters that may limit the frame duration, frame type, channel reservation limit, and number of frames that can be sent after each EDCA channel access in each sub-window. In some embodiments, each sub-window may include one or more timeslots for channel access contention. In some embodiments, the AP 110 may broadcast a structure for a channel access window that is composed of two sub-windows, where the first sub-window is associated with the AC_VO traffic and the second sub-window is associated with the AC_VI traffic. Therefore, only STAs that need to send AC_VO or AC_VI traffic may be permitted to compete for channel access during the announced window. The duration of each sub-window may be determined by the number of its timeslots. In some embodiments, the AP 110 may determine the number of timeslots per sub-window. The determination may be based on information such as the number of SCS agreements established by STAs, the number of collisions detected by the AP 110, and/or other information.

In some embodiments, the AP 110 may broadcast a structure for a channel access window with the following parameters for both sub-windows, (1) STAs are allowed to send initial frames (first frame sent after an EDCA channel access) that are shorter than a certain duration and/or (2) there is no restriction on the frame types sent. In some embodiments, the AP 110 sends a CTS frame 902 to start the channel access window 904. Both STA 1 and STA 2 may desire to send traffic that belongs to AC_VO such that STA 1 and STA 2 both compete during sub-window 1, which is assigned to AC_VO channel access contention. As illustrated in FIG. 9, STA 2 may capture the data channel first and may therefore sends a data frame belonging to AC_VO. The duration of the frame may be shorter than the specified threshold value. When STA 1 captures the data channel, STA 1 may send an RTS frame to reserve the data channel. After receiving the CTS frame 902 from the AP 110 and successful channel reservation, STA 1 may send a data frame which carries AC_VO data traffic.

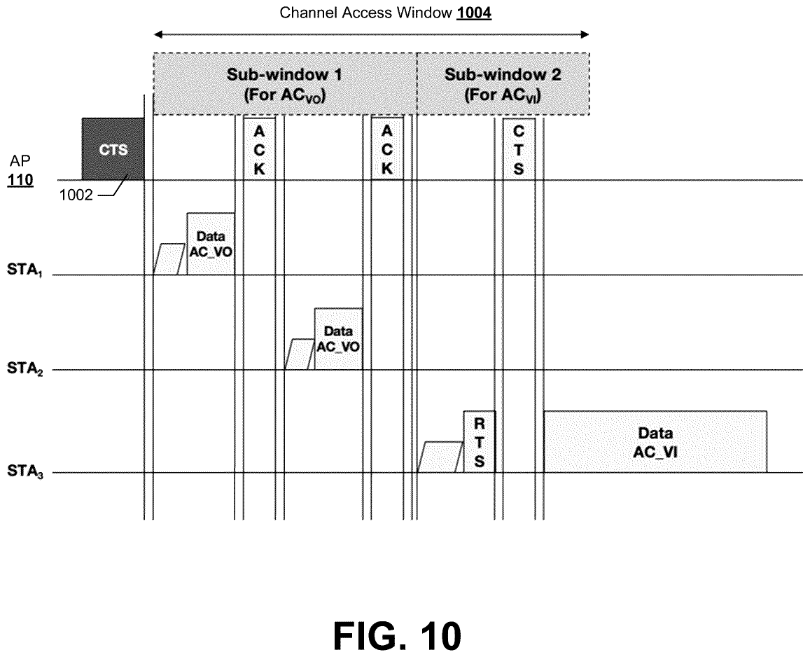

FIG. 10 illustrates example transmissions associated with AP 110 and one or more STAs, according to one or more embodiments. In some embodiments, the AP 110 may broadcast information associated with a channel access window 1004 with the following parameters: (1) in sub-window 1, STAs are permitted to send only data frames whose duration is no longer than a specified threshold, (2) in sub-window 1, STAs are not permitted to reserve the channel for a duration longer than SIFS+ACK after the frame transmission completion (e.g.,. the initial frame transmission completion), and/or (3) in sub-window 2, STAs can send any initial frame whose duration is no longer than a certain threshold. In some embodiments, the AP 110 may transmit a CTS frame 1002 to begin the channel access window 1004. The CTS frame 1002 may restrict a duration of the initial frames sent by the STAs during the channel access window 1004. Both STA 1 and STA 2 may desire to send data belonging to AC_VO such that the STAs compete for data channel access during sub-window 1. As illustrated in FIG. 10, STA 1 may capture the data channel in sub-window 1 and the STA 1 may send a data frame which is no longer than the frame limit duration enforced by the AP 110. Additionally, as illustrated in FIG. 10, STA 2 may capture the channel in sub-window 1 and may send a data frame, which is no longer than the frame limit duration enforced by the AP 110. STA 3 may compete for data channel access during sub-window 2 since the STA 3 desires to send AC_VI traffic. As such, the STA 3 may send an RTS, receive the CTS frame 1002, and then sends a data frame. In some embodiments, there is no limit on the size of the data frame (second frame) sent by STA 3 as the data frame is sent after the initial frame (e.g., RTS).

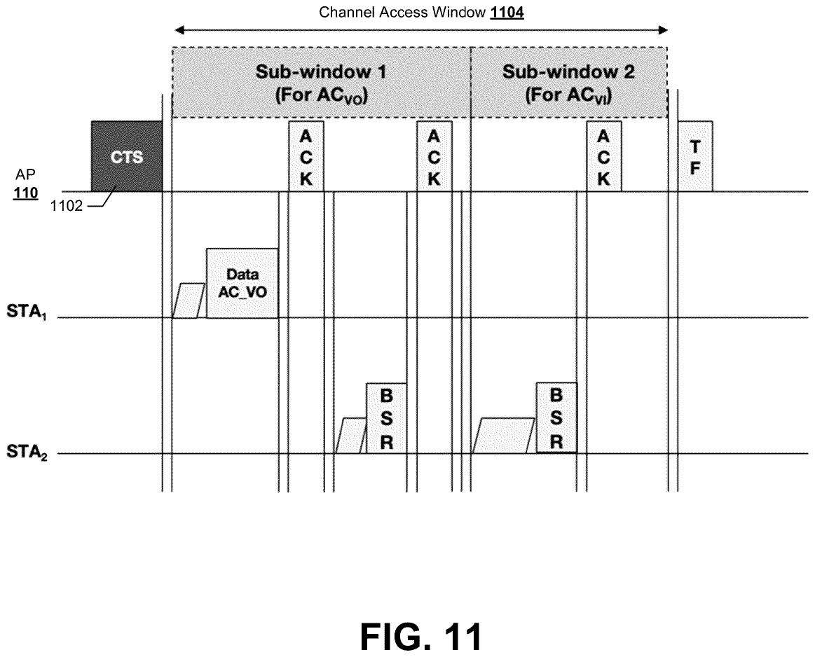

FIG. 11 illustrates example transmissions associated with AP 110 and one or more STAs, according to one or more embodiments. In some embodiments, the AP 110 may broadcast information associated with a channel access window 1104 with the following parameters in both sub-windows (1) STAs are permitted to send frames that are no longer than a certain threshold and/or (2) STAs are not permitted to reserve the channel for a duration longer than SIFS+ACK after the initial frame transmission completion. In other words, the AP 110 may broadcast information associated with a channel access window 1104 such that STAs are not permitted to send RTS or reserve a TXOP. In some embodiments, the AP 110 may permit the STAs to send data or BSR frames subject to the one or more prioritized access parameters and/or the channel access window information provided by the AP 110. At the end or in the middle of the channel access window 1104, the AP 110 may capture the data channel to initiate uplink transmissions from STAs that reported BSR. In some embodiments, the AP 110 may send a CTS frame 1102 to start the channel access window 1104. As illustrated in FIG. 11, STA 1 and STA 2 both desire to send data belonging to AC_VO. As such, the STA 1 and STA 2 may compete for data channel access in sub-window 1. STA 1 may send a data frame that belongs to AC_VO. The duration of the data frame may be no larger than the enforced frame duration limit. In sub-window 1, rather than transmitting a data type frame, STA 2 may send a BSR frame to inform the AP 110 that the STA 2 desires to send uplink AC_VO traffic. Additionally, STA 2 may utilize sub-window 2 to inform the AP 110 that the STA 2 desires to send uplink AC_VI traffic via a BSR frame. In some embodiments, after the channel access window 1104, the AP 110 may capture the data channel and transmit a trigger frame to initiate uplink transmissions based on one or more BSR frames the AP 110 may have received during the preceding channel access window 1104.

FIG. 12 illustrates a flowchart depicting a method 1200, FIG. 13 illustrates a flowchart depicting a method 1300, FIG. 14 illustrates a flowchart depicting a method 1400, and FIG. 15 illustrates a flowchart depicting a method 1500 according to one or more example embodiments of the present disclosure. It will be understood that each block of the flowcharts and combination of blocks in the flowcharts can be implemented by various means, such as hardware, firmware, processor, circuitry, and/or other communication devices associated with execution of software including instructions, for example one or more computer program instructions. For example, one or more of the procedures described above can be embodied by computer program instructions. In this regard, the computer program instructions which embody the procedures described above can be stored, for example, by the memory 210 of the apparatus 200 employing an embodiment of the present disclosure and executed by the processor 205. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Referring now to FIG. 12, the operations performed, such as by the apparatus 200 of FIG. 2, in order to enable a prioritized EDCA procedure for prioritized data traffic of a communication network, in accordance with one or more embodiments of the present disclosure. In some embodiments, the method 1200 is associated with functionality of the STA 115 or another STA. As shown in block 1202 of FIG. 12, the apparatus 200 includes means, such as the processor 205, the memory 210, or the like, configured to receive one or more prioritized access parameters to be utilized for data traffic that satisfies at least one priority criterion for accessing a data channel. In some embodiments, the one or more prioritized access parameters comprise a prioritized access parameter associated with AIFS information for the data channel. In some embodiments, the one or more prioritized access parameters additionally or alternatively comprise a prioritized access parameter associated with a contention window size for the data channel. In some embodiments, the one or more prioritized access parameters additionally or alternatively comprise a prioritized access parameter associated with a transmission opportunity limit for the data channel. In some embodiments, the one or more prioritized access parameters are included in an augmented set of enhanced distributed channel access, EDCA, parameters for the data channel. In some embodiments, the apparatus 200 additionally or alternatively includes means, such as the processor 205, the memory 210, or the like, configured to receive the one or more prioritized access parameters via a management frame associated with the data channel.

As shown in block 1204 of FIG. 12, the apparatus 200 additionally or alternatively includes means, such as the processor 205, the memory 210, or the like, configured to obtain a transmission opportunity for one or more data frames via the data channel based on the one or more prioritized access parameters. As shown in block 1206 of FIG. 12, the apparatus 200 additionally or alternatively includes means, such as the processor 205, the memory 210, or the like, configured to transmit the one or more data frames via the data channel.

In some embodiments, the apparatus 200 additionally or alternatively includes means, such as the processor 205, the memory 210, or the like, configured to receive information associated with a window for utilization of the one or more prioritized access parameters via the data channel. In some embodiments, the apparatus 200 additionally or alternatively includes means, such as the processor 205, the memory 210, or the like, configured to transmit the one or more data frames based on the window.

Referring now to FIG. 13, the operations performed, such as by the apparatus 200 of FIG. 2, in order to enable a prioritized EDCA procedure for prioritized data traffic of a communication network, in accordance with one or more embodiments of the present disclosure. In some embodiments, the method 1300 is associated with functionality of the AP 110 or another AP. As shown in block 1302 of FIG. 13, the apparatus 200 includes means, such as the processor 205, the memory 210, or the like, configured to determine one or more prioritized access parameters to be utilized for data traffic that satisfies at least one priority criterion for accessing a data channel. In some embodiments, the one or more prioritized access parameters comprise a prioritized access parameter associated with AIFS information for the data channel. In some embodiments, the one or more prioritized access parameters additionally or alternatively comprise a prioritized access parameter associated with a contention window size for the data channel. In some embodiments, the one or more prioritized access parameters additionally or alternatively comprise a prioritized access parameter associated with a transmission opportunity limit for the data channel. As shown in block 1304 of FIG. 13, the apparatus 200 additionally or alternatively includes means, such as the processor 205, the memory 210, or the like, configured to transmit the one or more prioritized access parameters to one or more stations associated with the data channel.

In some embodiments, the apparatus 200 additionally or alternatively includes means, such as the processor 205, the memory 210, or the like, configured to transmit the one or more prioritized access parameters via a management frame associated with the data channel.

In some embodiments, the apparatus 200 additionally or alternatively includes means, such as the processor 205, the memory 210, or the like, configured to determine a window for utilization of the one or more prioritized access parameters via the data channel. The window may be a channel access window for the data channel. In some embodiments, the apparatus 200 additionally or alternatively includes means, such as the processor 205, the memory 210, or the like, configured to transmit information associated with the window to the one or more stations associated with the data channel.

In some embodiments, the apparatus 200 additionally or alternatively includes means, such as the processor 205, the memory 210, or the like, configured to configure the window based on one or more modification rules for reducing a contention window associated with the data traffic. In some embodiments, the apparatus 200 additionally or alternatively includes means, such as the processor 205, the memory 210, or the like, configured to configure the window based on one or more modification rules for increasing or decreasing a size of the window responsive to failed transmission of a data packet via at least one of the one or more stations. In some embodiments, the apparatus 200 additionally or alternatively includes means, such as the processor 205, the memory 210, or the like, configured to determine an interval of time for the window for utilization of the one or more prioritized access parameters via the data channel. In some embodiments, the apparatus 200 additionally or alternatively includes means, such as the processor 205, the memory 210, or the like, configured to determine a start position for the window based on a start position of a control frame associated with the data channel. In some embodiments, the apparatus 200 additionally or alternatively includes means, such as the processor 205, the memory 210, or the like, configured to determine a start position for the window based on an end position of a control frame associated with the data channel.

Referring now to FIG. 14, the operations performed, such as by the apparatus 200 of FIG. 2, in order to enable a prioritized EDCA procedure for prioritized data traffic of a communication network via a channel access window, in accordance with one or more embodiments of the present disclosure. In some embodiments, the method 1400 is associated with functionality of the STA 115 or another STA. As shown in block 1402 of FIG. 14, the apparatus 200 includes means, such as the processor 205, the memory 210, or the like, configured to receive, for a channel access window associated with a data channel, one or more prioritized access parameters to be utilized for data traffic that satisfies at least one priority criterion for the channel access window. As shown in block 1404 of FIG. 14, the apparatus 200 additionally or alternatively includes means, such as the processor 205, the memory 210, or the like, configured to transmit, based on the one or more prioritized access parameters, prioritized data traffic via one or more data frames after capturing the data channel using Enhanced Distributed Channel Access (EDCA). For example, the one or more prioritized access parameters may be for the channel access window.

In some embodiments, the apparatus 200 additionally or alternatively includes means, such as the processor 205, the memory 210, or the like, configured to receive a frame type parameter of the one or more prioritized access parameters that is indicative of a type of data frame that is permissible for transmission after the capturing of the data channel using the EDCA. In some embodiments, the apparatus 200 additionally or alternatively includes means, such as the processor 205, the memory 210, or the like, configured to transmit the prioritized data traffic based on the frame type parameter.

In some embodiments, the apparatus 200 additionally or alternatively includes means, such as the processor 205, the memory 210, or the like, configured to receive a frame duration parameter of the one or more prioritized access parameters that is indicative of a maximum permissible duration for a first data frame that is permissible for transmission after the capturing of the data channel using the EDCA. In some embodiments, the apparatus 200 additionally or alternatively includes means, such as the processor 205, the memory 210, or the like, configured to transmit the prioritized data traffic based on the frame duration parameter.

In some embodiments, the apparatus 200 additionally or alternatively includes means, such as the processor 205, the memory 210, or the like, configured to receive a channel reservation duration parameter of the one or more prioritized access parameters that is indicative of a maximum amount of time the apparatus 200 is permitted to reserve the data channel after the capturing of the data channel using the EDCA. In some embodiments, the apparatus 200 additionally or alternatively includes means, such as the processor 205, the memory 210, or the like, configured to transmit the prioritized data traffic based on the channel reservation duration parameter.

In some embodiments, the apparatus 200 additionally or alternatively includes means, such as the processor 205, the memory 210, or the like, configured to receive a frame number parameter of the one or more prioritized access parameters that is indicative of a maximum number of frames the apparatus 200 is permitted to transmit after the capturing of the data channel using the EDCA. In some embodiments, the apparatus 200 additionally or alternatively includes means, such as the processor 205, the memory 210, or the like, configured to transmit the prioritized data traffic based on the frame number parameter.

In some embodiments, the apparatus 200 additionally or alternatively includes means, such as the processor 205, the memory 210, or the like, configured to receive a data channel parameter of the one or more prioritized access parameters that is indicative of a maximum number of times the apparatus 200 is permitted to capture the data channel using the EDCA during the channel access window. In some embodiments, the apparatus 200 additionally or alternatively includes means, such as the processor 205, the memory 210, or the like, configured to transmit the prioritized data traffic based on the data channel parameter.

In some embodiments, the one or more parameters is associated with a first sub-window of the channel access window. In some embodiments, the apparatus 200 additionally or alternatively includes means, such as the processor 205, the memory 210, or the like, configured to receive one or more different prioritized access parameters for at least a second sub-window of the channel access window. In some embodiments, the apparatus 200 additionally or alternatively includes means, such as the processor 205, the memory 210, or the like, configured to transmit the prioritized data traffic via the data channel based on the one or more different prioritized access parameters.

In some embodiments, the one or more parameters is associated with a first access category for the channel access window. In some embodiments, the apparatus 200 additionally or alternatively includes means, such as the processor 205, the memory 210, or the like, configured to receive one or more different priority access parameters for at least a second access category for the channel access window. In some embodiments, the apparatus 200 additionally or alternatively includes means, such as the processor 205, the memory 210, or the like, configured to transmit the prioritized data traffic based on the one or more different priority access parameters.

In some embodiments, the one or more parameters is associated with a first data stream type associated with the data channel. In some embodiments, the apparatus 200 additionally or alternatively includes means, such as the processor 205, the memory 210, or the like, configured to receive one or more different priority access parameters for a at least a second data stream type associated with the data channel, wherein the second data stream type is defined between the apparatus 200 and an access point. In some embodiments, the apparatus 200 additionally or alternatively includes means, such as the processor 205, the memory 210, or the like, configured to transmit the prioritized data traffic based on the one or more different priority access parameters.

Referring now to FIG. 15, the operations performed, such as by the apparatus 200 of FIG. 2, in order to enable a prioritized EDCA procedure for prioritized data traffic of a communication network via a channel access window, in accordance with one or more embodiments of the present disclosure. In some embodiments, the method 1500 is associated with functionality of the AP 110 or another AP. As shown in block 1502 of FIG. 15, the apparatus 200 includes means, such as the processor 205, the memory 210, or the like, configured to determine, for a channel access window associated with a data channel, one or more prioritized access parameters to be utilized for data traffic that satisfies at least one priority criterion for Enhanced Distributed Channel Access (EDCA). As shown in block 1504 of FIG. 15, the apparatus 200 additionally or alternatively includes means, such as the processor 205, the memory 210, or the like, configured to transmit the one or more prioritized access parameters to one or more stations associated with the data channel.

In some embodiments, the apparatus 200 additionally or alternatively includes means, such as the processor 205, the memory 210, or the like, configured to determine a frame type parameter indicative of a type of data frame that is permissible for transmission after the capturing of the data channel using the EDCA.

In some embodiments, the apparatus 200 additionally or alternatively includes means, such as the processor 205, the memory 210, or the like, configured to transmit the frame type parameter to the one or more stations associated with the data channel.

In some embodiments, the apparatus 200 additionally or alternatively includes means, such as the processor 205, the memory 210, or the like, configured to determine a frame duration parameter indicative of a maximum permissible duration for a first data frame that is permissible for transmission after the capturing of the data channel using the EDCA. In some embodiments, the apparatus 200 additionally or alternatively includes means, such as the processor 205, the memory 210, or the like, configured to transmit the frame duration parameter to the one or more stations associated with the data channel.

In some embodiments, the apparatus 200 additionally or alternatively includes means, such as the processor 205, the memory 210, or the like, configured to determine a channel reservation duration parameter indicative of a maximum amount of time a station is permitted to reserve the data channel after the capturing of the data channel using the EDCA. In some embodiments, the apparatus 200 additionally or alternatively includes means, such as the processor 205, the memory 210, or the like, configured to transmit the channel reservation duration parameter to the one or more stations associated with the data channel.

In some embodiments, the apparatus 200 additionally or alternatively includes means, such as the processor 205, the memory 210, or the like, configured to determine a frame number parameter indicative of a maximum number of frames a station is permitted to transmit after the capturing of the data channel using the EDCA. In some embodiments, the apparatus 200 additionally or alternatively includes means, such as the processor 205, the memory 210, or the like, configured to transmit the frame number parameter to the one or more stations associated with the data channel.

In some embodiments, the apparatus 200 additionally or alternatively includes means, such as the processor 205, the memory 210, or the like, configured to determine a data channel parameter indicative of a maximum number of times the apparatus 200 is permitted to capture the data channel using the EDCA during the channel access window. In some embodiments, the apparatus 200 additionally or alternatively includes means, such as the processor 205, the memory 210, or the like, configured to transmit the data channel parameter to the one or more stations associated with the data channel.

In some embodiments, the one or more parameters is associated with a first sub-window of the channel access window. In some embodiments, the apparatus 200 additionally or alternatively includes means, such as the processor 205, the memory 210, or the like, configured to determine one or more different prioritized access parameters for at least a second sub-window of the channel access window. In some embodiments, the apparatus 200 additionally or alternatively includes means, such as the processor 205, the memory 210, or the like, configured to transmit the one or more different priority access parameters to the one or more stations.

In some embodiments, the one or more parameters is associated with a first access category for the channel access window. In some embodiments, the apparatus 200 additionally or alternatively includes means, such as the processor 205, the memory 210, or the like, configured to determine one or more different priority access parameters for at least a second access category for the channel access window. In some embodiments, the apparatus 200 additionally or alternatively includes means, such as the processor 205, the memory 210, or the like, configured to transmit the one or more different priority access parameters to the one or more stations.

In some embodiments, the one or more parameters is associated with a first data stream associated with the data channel. In some embodiments, the apparatus 200 additionally or alternatively includes means, such as the processor 205, the memory 210, or the like, configured to determine one or more different priority access parameters for at least a second data stream associated with the data channel, wherein the second data stream type is defined between the apparatus 200 and a station. In some embodiments, the apparatus 200 additionally or alternatively includes means, such as the processor 205, the memory 210, or the like, configured to transmit the one or more different priority access parameters to the one or more stations.

As described above, FIGS. 12-15 are flowcharts of various methods that can be carried out by, e.g., the apparatus 200, and/or according to a computer program product, according to an example embodiment of the disclosure. A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as, e.g., in conjunction with the communications flowchart of FIG. 12, communications flowchart of FIG. 13, communications flowchart of FIG. 14, communications flowchart of FIG. 15, as part of the communication system of FIG. 1, as part of the signaling flow diagram of FIG. 3, as part of the signaling flow diagram of FIG. 4, as part of the signaling flow diagram of FIG. 6, as part of the signaling flow diagram of FIG. 7, as part of the signaling flow diagram of FIG. 8, as part of the signaling flow diagram of FIG. 9, as part of the signaling flow diagram of FIG. 10, and/or as part of the signaling flow diagram of FIG. 11. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments presented herein and that modifications and other embodiments are intended to be included within the scope of the appended claims. Although specific terms are employed herein, they are used in a generic and descriptive sense only and not for purposes of limitation.

1. An apparatus comprising:
at least one processor; and
at least one memory storing instructions that, when executed by the at least one processor, cause the apparatus to:
receive one or more prioritized access parameters to be utilized for data traffic that satisfies at least one priority criterion for accessing a data channel;
obtain a transmission opportunity for one or more data frames via the data channel based on the one or more prioritized access parameters; and
transmit the one or more data frames via the data channel.

2. The apparatus of claim 1, further configured to:
receive the one or more prioritized access parameters via a management frame associated with the data channel.

3. The apparatus of claim 1, further configured to:
receive information associated with a window for utilization of the one or more prioritized access parameters via the data channel; and
transmit the one or more data frames based on the window.

4. The apparatus of claim 1, wherein the one or more prioritized access parameters comprise a prioritized access parameter associated with arbitration inter-frame spacing, AIFS, information for the data channel.

5. The apparatus of claim 1, wherein the one or more prioritized access parameters comprise a prioritized access parameter associated with a contention window size for the data channel.

6. The apparatus of claim 1, wherein the one or more prioritized access parameters comprise a prioritized access parameter associated with a transmission opportunity limit for the data channel.

7. The apparatus of claim 1, wherein the one or more prioritized access parameters are included in an augmented set of enhanced distributed channel access, EDCA, parameters for the data channel.

8. An apparatus comprising:
at least one processor; and
at least one memory storing instructions that, when executed by the at least one processor, cause the apparatus to:
determine one or more prioritized access parameters to be utilized for data traffic that satisfies at least one priority criterion for accessing a data channel; and
transmit the one or more prioritized access parameters to one or more stations associated with the data channel.

9. The apparatus of claim 8, further configured to:
transmit the one or more prioritized access parameters via a management frame associated with the data channel.

10. The apparatus of claim 8, further configured to:
determine a window for utilization of the one or more prioritized access parameters via the data channel; and
transmit information associated with the window to the one or more stations associated with the data channel.

11. The apparatus of claim 10, further configured to:
configure the window based on one or more modification rules for reducing a contention window associated with the data traffic.

12. The apparatus of claim 10, further configured to:
configure the window based on one or more modification rules for increasing or decreasing a size of the window responsive to failed transmission of a data packet via at least one of the one or more stations.

13. The apparatus of claim 10, further configured to:
determine an interval of time for the window for utilization of the one or more prioritized access parameters via the data channel.

14. The apparatus of claim 10, further configured to:
determine a start position for the window based on a start position of a control frame associated with the data channel.

15. The apparatus of claim 10, further configured to:
determine a start position for the window based on an end position of a control frame associated with the data channel.

16. The apparatus of claim 8, wherein the one or more prioritized access parameters comprise a prioritized access parameter associated with arbitration inter-frame spacing, AIFS, information for the data channel.

17. The apparatus of claim 8, wherein the one or more prioritized access parameters comprise a prioritized access parameter associated with a contention window size for the data channel.

18. The apparatus of claim 8, wherein the one or more prioritized access parameters comprise a prioritized access parameter associated with a transmission opportunity limit for the data channel.

19. A method, comprising:
receiving one or more prioritized access parameters to be utilized for data traffic that satisfies at least one priority criterion for accessing a data channel;
obtaining a transmission opportunity for one or more data frames via the data channel based on the one or more prioritized access parameters; and
transmitting the one or more data frames via the data channel.

20. A method, comprising:
determining one or more prioritized access parameters to be utilized for data traffic that satisfies at least one priority criterion for accessing a data channel; and
transmitting the one or more prioritized access parameters to one or more stations associated with the data channel.
